(19) United States
(12) Patent Application Publication
(10) Pub. No.: US 2021/0394257 A1
(43) Pub. Date: Dec. 23, 2021

(54) METHOD FOR STEPPED RADIAL COOLING PASSAGES IN GAS TURBINE BLADE

(71) Applicant: Mohammed Naseri, (US)

(72) Inventor: Mohammed Naseri, (US)

(73) Assignee: Mapna group, Tehran (IR)

(21) Appl. No.: 17/306,980

(22) Filed: May 4, 2021

(51) Int. Cl. B22C 9/10; F01D 5/18; B22D 29/00; B22D 17/22

(52) U.S. Cl. CPC B22C 9/10; F01D 5/18; F05D 2220/32; B22D 17/22; F05D 2230/21; B22D 29/002

(57) ABSTRACT

A new method for providing stepped radial cooling channels for use in investment casting process, particularly for producing gas turbine blades or vanes, is disclosed. The process involves selecting the cores with two different diameters, smaller diameter cores for airfoil channels and larger diameter cores for root channels. The airfoil cores are bended via especial fixture due to angular design of airfoil relative to root of blade. Then the airfoil cores are inserted into the root cores whereas bended segment of airfoil cores are completely located and locked into the root cores without any requirement to glue or cement at their junction or welding the junction. Then the pairs of cores are placed in the injection wax mold having a cavity with a shape complementary to the final casting design and plurality of grooves therein. Each groove of the mold has a depth equal to a radius of certain number of ceramic cores which correspond to cooling channels of casting. Then the wax is injected for temporary positioning of the cores. The wax blade and located cores therein form a pattern for investment casting.

### TECHNICAL FIELD

This invention relates generally to the field of investment casting, and more particularly, using cores to create cooling passages in the components, e.g. complex passages in cast blades for use in gas turbine engines.

### BACKGROUND

Most manufactures of gas turbine engine components are evaluating advanced hollow turbine airfoils (i.e. turbine blade or vane) which include complex air cooling passages. The cooling passages are of different shapes and sizes depending on the type and power of gas turbine engine, the row of blade, the size of blade, the design of blade and etc.

One of the types of cooling passages is the internal radial channels. The turbine blade includes two more important parts, a root and airfoil. In this type of cooling system, channels of airfoil and root may have same or different diameter. When the diameter of channel does not change along the length of the blade, silica rich or quartz cores can be used easily. In addition, traditional drilling techniques such as STEM (shaped tube electrolytic machining) for these applications are currently used.

But when the diameters of channel are different in root and airfoil parts, that called stepped radial channels, making passages are conducted only by STEM technique. However the high cost of machining operation and its maintenance result in a higher cost component than achievable with cored passage only.

Adjustment of application machining parameters is more complex and besides, the undesired dimensional deviations of airfoils because of casting variations and also finishing and rework operations for removal different inclusions, can lead disturb the position of holes from their preferred position and even lead to scrap parts, resulted in lower casting yield.

Furthermore, the holes are encountered together from two opposite directions, tip of blade and bottom of blade, occasionally have mismatch in their junction whereas they are not exactly in front of together as called they are not concentric because the channels almost always are not straight because the angular misalignment of blade design.

On the other hand, more easily deformable, leachable and cheap core materials, such as quartz, are extruded, not injected, and therefore cannot be manufactured economically with discontinuities such as diameter variations. Conventional ceramic core materials produced by injection, such as alumina or zirconia and the like, are too rigid to be easily bent and are extremely difficult to remove from the casting by conventional leaching techniques.

For producing stepped radial holes, two cores with different diameters can be joined together by techniques such as fusion welding or glued together using cement or past, as disclosed in U.S. Pat. No. 6,029,736 of Rajeev V. Naik et al (discloses use of cement and glue at adjacent ends of quartz cores). But the junction of cores has no sufficient strength and it is more likely break during different stages of investment casting consisting of wax pattern injection, shell making, dewaxing for wax removal, shell firing and casting.

There, thus is a need for an improved method for producing stepped radial cooling, so an object of the present invention is to provide a new method by using quartz cores. The preferred method eliminates the use of STEM technique which requires comprehensive instruments and increases the cost of production.

### SUMMARY

To this end, the present invention provides a stepped radial cores for use in casting a melt wherein the each stepped radial core of blade comprises a pair of two tabular quartz cores with different diameter assembled together whereas a smaller diameter core belonged to airfoil hole inserted into a larger diameter core belonged to root hole of blade.

In one embodiment of this invention, the extents of external diameters of small and large cores are exactly equal to extent diameters of airfoil and root holes, respectively.

Since the smaller core goes into the larger core, the internal diameter of larger core is determined by external diameter of smaller core with clearance gap about 0.0004 to 0.0008 inch, that compensates the difference between thermal expansions of smaller core and larger core during high temperature processes of firing of the shell and casting.

Furthermore, when this gap is decreased than 0.0004 inch, the smaller core cannot be inserted into larger core because of friction between the cores. When the gap becomes more than 0.0008 inch, the smaller core moves easily into larger core and its position is corrupted during investment casting processes such as wax injection, and also melt leaks into the space around of smaller core thereby causing scrap the part.

In another embodiment of the invention, smaller core with extra length of about 4 inches is employed for better locking in the larger core. Additionally, due to angular misalignment of airfoil channel relation to root channel of blade, the smaller core is bended by oxy acetylene flame in special fixture (in according of channel angle), whereas the bended part of this core is completely inserted into the larger core that helps the better assembling of cores. So the bended segment is sufficient for locking the airfoil cores in root cores whereas there is no need to any glue or cement between the cores and also there is no need to weld the airfoil cores to root cores.

In one embodiment of the invention, the thin-walled quartz tabular cores are employed for airfoil channels having a wall thickness between about 0.01-0.015 inch to reduce distortion or sagging of each pair of cores in the high temperature processes from tube weight and also better removal of the cores via leaching.

As mentioned above, from embodiment of this invention, the thickness of root cores is determined by external diameter of airfoil core and diameter of channel in root part of blade.

After providing the cores, they are seated into the mold cavity; wax is then injected and surrounds the cores. Wax pattern containing cores is now prepared for investment casting. A ceramic shell is formed about the wax until required thickness, and wax is removed by conventional dewaxing methods, leaving a cavity includes positioned cores therein. For achieve required strength the shell is fired in high temperature. Molten metal is then cast into the cavity to form the blade or vane. After metal is cooled, conventional leaching is used to remove quartz cores from the interior of casting to create stepped radial cooling channels.

Further objects and advantages of the present invention will become more apparent from the detailed following description taken with the drawings.

### BRIEF DESCRIPTION OF DRAWINGS

FIG. 1 illustrates a perspective view of tabular ceramic cores designed for airfoil of casting in accordance with the present invention.

FIG. 2 illustrates a perspective view of tabular ceramic cores designed for root of casting in accordance with the present invention.

FIG. 3 is a perspective view of tabular ceramic cores of airfoil after bending in accordance with the present invention.

FIG. 4 is a perspective view of several pairs of tabular cores, a1b1-a5b5, which each pair comprises airfoil core and root core.

FIG. 5 is a sectional view of a1b1 core showing airfoil core inserted into root core until its bend.

FIG. 6 is a partial sectional view of a1b1 core at the joint of airfoil core and root core.

FIG. 7.A is a top view of the bottom half of injection mold for injection wax.

FIG. 7.B is a top view of the top half of injection mold for injection wax.

FIG. 8 is a schematic view of a wax blade comprises positioned cores therein.

FIG. 9 is a schematic view of an investment casting shell formed over the wax pattern and cores.

FIG. 10 is a schematic view of the blade casting with stepped internal cooling channels, containing small diameter channels in airfoil and large diameter channels in root of blade.

### DETAILED DESCRIPTION

The present invention includes a method for creating stepped radial coolings to use in casting a nickel or cobalt base superalloys gas turbine blade or vane. Employing two groups of quartz cores that positioned in wax pattern through injection mold, stepped radial cooling channels are created by investment casting of wax pattern.

In this invention although quartz tubes are used, the invention is not so limited and can be practiced using other silica materials such as mullite or another ceramic cores such as alumina, silicon nitride, . . .

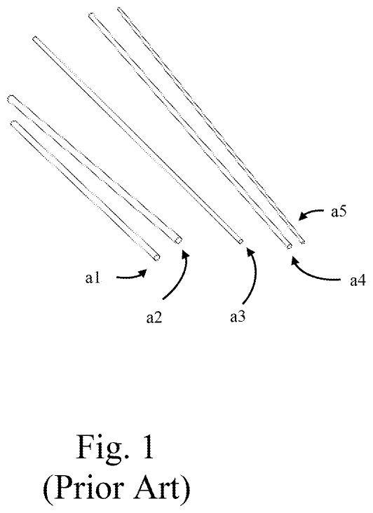

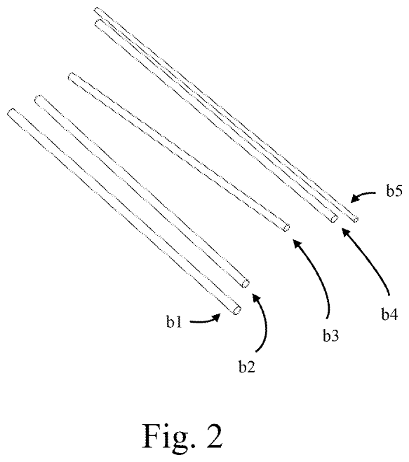

FIG. 1 shows the group a of tabular quartz cores, belonged to airfoil of blade and FIG. 2 shows the group b of tabular quartz cores, belonged to root of blade. According to arrangement of cooling passages in the turbine blade, the cores were marked from a1 to a5, in FIG. 1 and b1 to b5, in FIG. 2, where number 1 is adjacent the leading edge and number 5 is adjacent the trailing edge of airfoil.

Although in this invention 5 pairs of tabular cores are used for a casting, but the invention can be used for less or more multiple cores according to the quantity of channels in casting. In this invention, the tubes are shown as cylindrical shape, but it is applicable for other tabular shapes, such as triangular shapes.

The cores in both of group have different diameters according to diameters of channels designed in blade. The cores a1, a2, a3, a4. a5 have outer diameter to exact diameter of airfoil channels. The cores b1, b2, b3, b4, b5 have larger outer diameter in comparison with group a, designed for root channels (have outer diameter to exact diameter of root channels).

The cores a1-a5 and b1-b5 can have the same length or different lengths as required for a given casting.

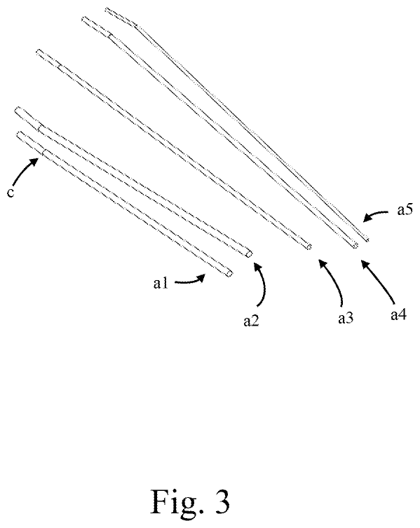

Generally, in each channel of blade the airfoil cores and root cores are connected at the junction of blade with the specified angle so in this invention the junction of cores is designed in group a of ceramic cores and the bend is conducted by oxyacetylene flame via special fixture. FIG. 3 illustrates airfoil cores with one bend c that the bend will be located in junction of airfoil and root of blade.

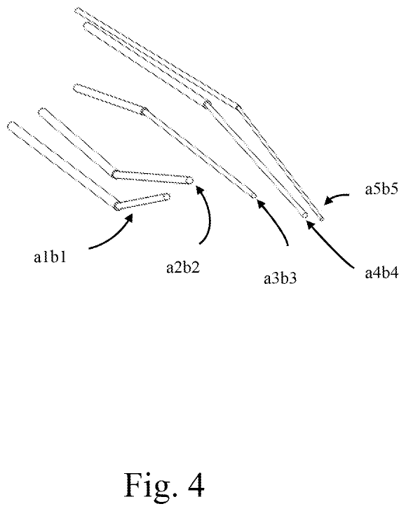

According to one embodiment of the invention, referring to FIG. 4, the cores of group a are inserted axially into the cores of group b until they reach the bends c. FIG. 4 shows each of pairs a1b1, a2b2, a3b3, a4b4, a5b5 together is provided for each channel, somewhat a1b1 is located in leading edge of blade and a5b5 is located in trailing edge of blade.

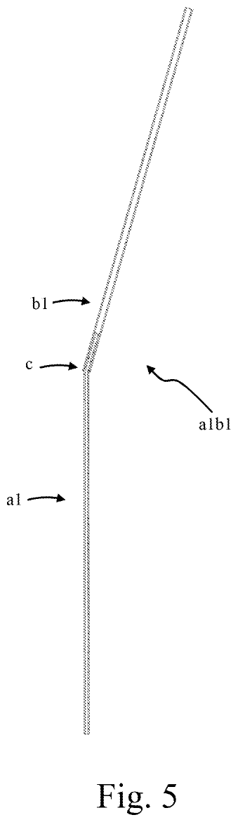

FIG. 5 shows the pair of a1b1 that the a1 core with extra bended section d is inserted into the b1 through the c, until it reaches the bend c, the length of the bended segment d is considered before in primary length of cores a1-a5, as its extent is about 4 inches. So the primary length of the a1-a5 before bending is comprised of length of airfoil channel and length of extra extent for bended segment d.

The outer diameter of airfoil cores a1-a5 typically is maintained of constant as it feasible for a given casting blade or vane to provide cooling channels with certain diameter.

In one embodiment of the inventions, several thin walled quartz tubular members are employed for cores a1-a5 having low wall thickness between about 0.01 inch and about 0.015 inch, because thin wall reduces sagging or distortion of the tube from their weights and provides better leaching rate of cores.

But since the airfoil cores are located in root cores, the wall thickness of cores b1-b5 is controlled relative to the outer diameter of cores a1-a5 to insure cores a1-a5 relatively close fit therein and hence maintain the core positions in primitive shape at high temperatures and yet provide enough clearance for free thermal expansion of cores a1-a5 inside the cores b1-b5 to avoid cracking of cores.

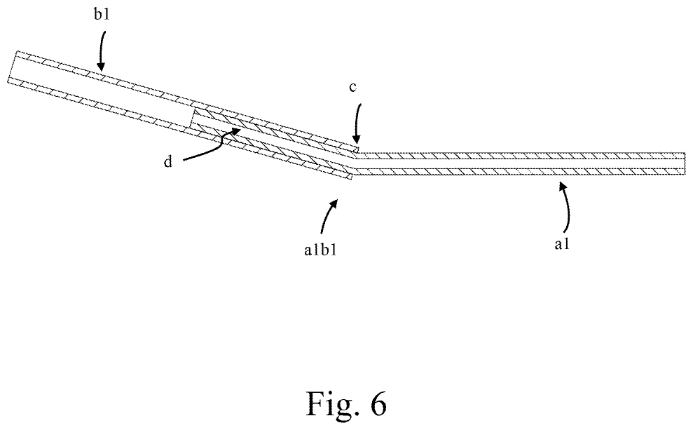

According in one embodiment of this invention, the difference between the diameter of groups a and b is about 0.0004 to 0.0008 inch (not shown) and conducted in all members of both groups. For instance, the difference between the diameter of core a1 and core b1 is partially shown in FIG. 6.

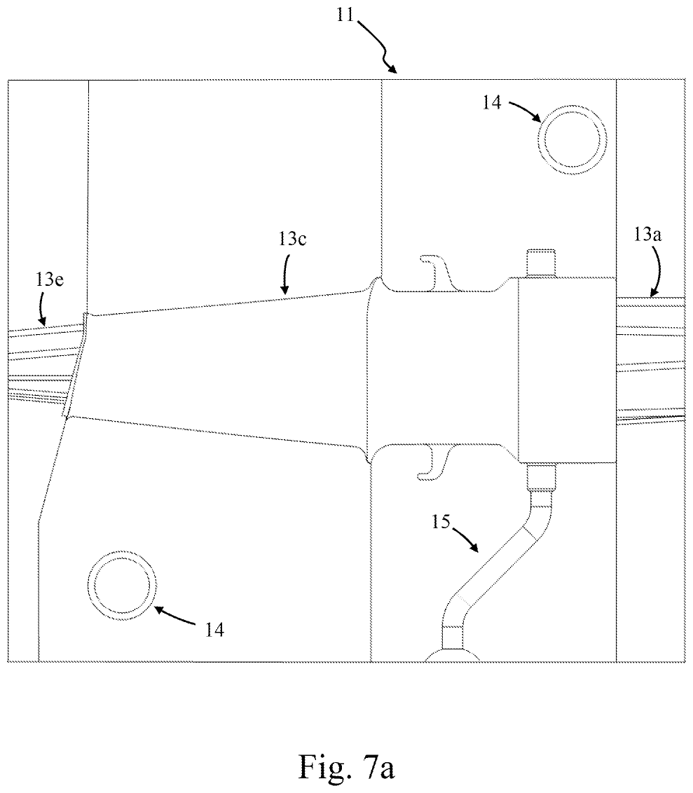

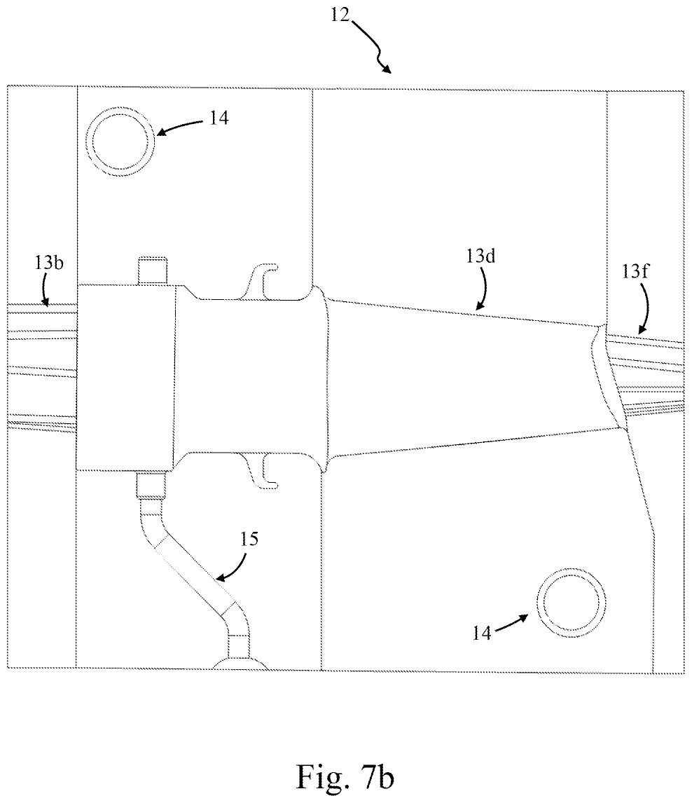

FIG. 7.A and FIG. 7.B illustrates a bottom half 11 and a top half 12 of an injection mold, respectively, for forming wax pattern that positions the cores. Each of these cavities includes constituents of a blade such as root, shank, platform, airfoil and shroud of blade and situations for seating the cores. The mold includes a duct 15 for supplying injected wax to the cavity and in addition the duct divides into two branches for each cavity.

The mold has a cavity 13 that including portions 13a, 13c and 13e in bottom half and 13b, 13d and 13f in top half. Bottom and top halves of mold are joined together by a hinge (not shown). When the two halves 11 and 12 of the mold are joined together in a closed position, by pin guides 14, portions 13a, 13b, 13c, 13d, 13e and 13f unit complete cavity.

A plurality of grooves is formed in the mold cavities, whereas the depth of each groove is equal to half of outer diameter of each member of each pair cores. Five pairs of tubular cores a1b1, a2b2, a3b3, a4b4 and a5b5 are placed in mold cavity while airfoil members with numbers a1, a2, a3, a4 and a5 are located in 13a and 13b and root members with numbers b1, b2, b3, b4 and b5 are located in 13e and 13f. Indeed, each core is seated in a certain groove in the own cavity. Then the portions of 13b and 13d are put on the 13a and 13c, respectively, to close the cavity and fix the positions of cores in their grooves.

After locating the cores in their seats, the wax is injected into cavity between 11 and 12 through duct 15 of mold to form a pattern in mold cavity 13c and 13d surrounding the cores. The all constituents of blade including as root, shank, platform, airfoil and shroud are formed in cavities 13c and 13d. In particular disposable pattern wax, plastic or other material is injected into the mold cavity and spaces between cores to form a pattern surrounds the all of cores (a1b1-a5b5).

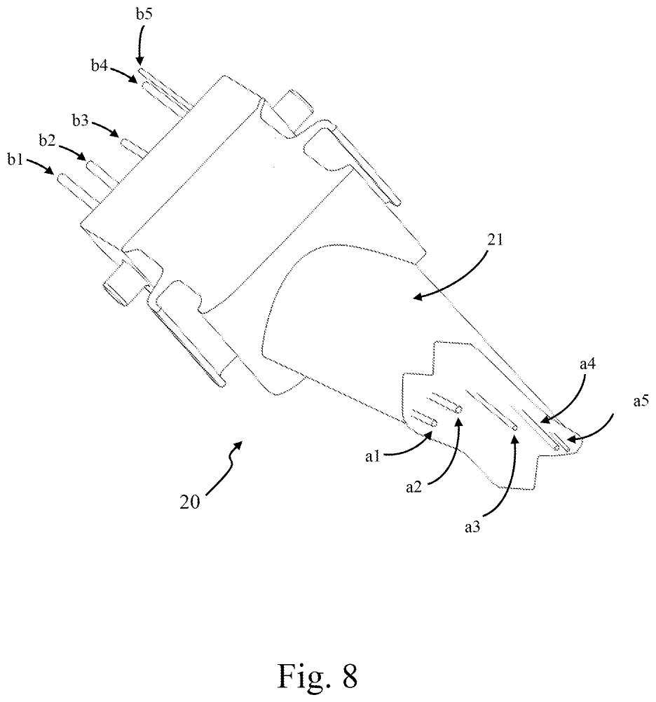

After the molten wax has solidified, the complex 20 including wax pattern 21, and positioned cores a1b1-a5b5 are removed from the mold as shown in FIG. 8. The airfoil members of cores a1-a5 and root members of cores b1-b5 extract from tip and root of blade, respectively.

Although the cores are located in their seats in injection mold, the direction of duct in injection mold can be designed parallel to length of cores for preventing displacement of cores that may be occurred due to flow of incoming wax. Also for minimizing the possibility of damage to the cores, it is better to use higher amount of releasing agent spray on the cores before injection. This reduces the mechanical pressure on the cores through decrease in friction between the cores and semi liquid wax.

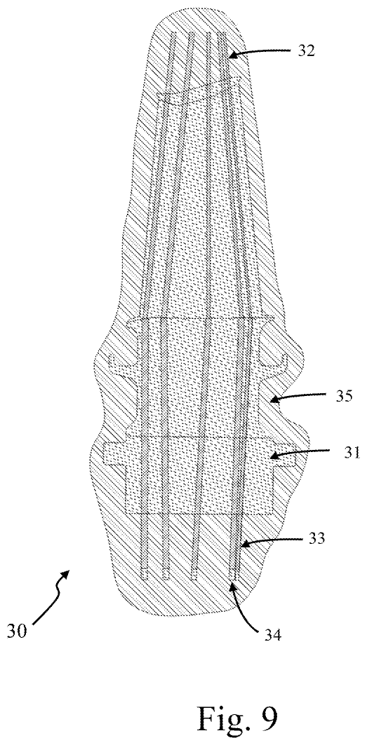

The upper end of the cores a1-a5 extending outside of tip of wax blade 32 in FIG. 9 are locked in ceramic shell for avoiding lateral movement of the cores but since the thermal expansion of the core and shell are different, at the end of the cores b1-b5, 33 in FIG. 9, extending from the root of blade, a little cylindrical wax 34 in FIG. 9 is added for assure the integrity of both members of cores.

After the dewaxing, the cylindrical wax 34 remains a blank space between the cores and shell and prevents failure of quartz cores due to different thermal expansion coefficients of quartz and the ceramic shell which including silica, alluminosilicate, zircon or other common shell materials and silica binder.

But as described above, for inhibition of disturb of the cores locations, another end of the cores 32 coming out from tip of blade is locked in ceramic shell 35 without any freedom, as illustrated in FIG. 9. The final patterns with slipping core strategies are assembled together on a cluster of wax and then are invested in ceramic shell. In FIG. 9 the complex 30 shows the shell 35 surround the wax blade 31, the airfoil cores in tip of blade 32, the root cores in bottom of blade 33, a little wax at end of root cores 34.

Construction of shell is usually carried out by applying a layer of the slurry (dipping the cluster in ceramic slurry) to the wax pattern, followed by applying a layer of coarse grain stucco (e.g., made from alluminosilicate) to wax pattern, and then repeating the process a number of times. The number of times the layer-stucco sequence is repeated until a shell mold is built up on the pattern to a desired thickness.

Sometimes shells become sensitive to cracking and bulging when they are exposed to the molten metal especially in case of heavy castings and very high pouring temperatures. Stress of cracking or dimensional variations in shells because of casting or firing is transmitted to the cores and could lead to damage the cores and even scrap of the casting. Therefore the shells require sufficient strength when they are exposed at high temperature processes such as firing and casting processes, e.g., in the range of 1000° C. to 1400° C.

After the ceramic shell has been completed, the wax is removed by one of several acceptable techniques. For example, dewaxing can be used by putting the shell into a steam autoclave, operating at a temperature of about 100° C.-200° C., under steam pressure of about 90-120 psi, for 10-20 minutes. These parameters are strongly depending on the exact dewaxing conditions and the quantity of shells within the autoclave vessel.

The ideal schedule is that a great amount of heat is transferred so quickly to the steam vessel before shell is cracked because of wax expansion is believed to be the major cause of shell cracking. For achieving this purpose, the external pressure on the shell surface is reached the ultimate value in 4-6 seconds.

The shell then is fired at elevated temperatures to develop mold strength for casting. Generally firing is carried out a temperature in the range of about 900° C.-1100° C. for about 30-60 minutes.

Although usually using high temperature and longtime of firing process improves strength of shell but it facilitates thermal phase transformations such as cristobalite formation. When the content of cristobalite phase in shell becomes larger than certain value, great dimensional deformation will be occurred in shell and consequently quartz cores may failure, so it is important the control of cristobalite phase content by adjustment of firing variables.

Molten superalloys such as nickel or cobalt based alloys then are introduced into the shell having cavity of blade or vane and cores located therein. Alternatively, the shell can be allowed to cool to room temperature until molten metal solidified in the shell about the cores to form casting blade or vane. The shell is removed from the casting using a mechanical knock-out operation. The cores are selectively removed from the casting by a typical leaching treatment in a conventional caustic solution at 180° C. for 18 hours.

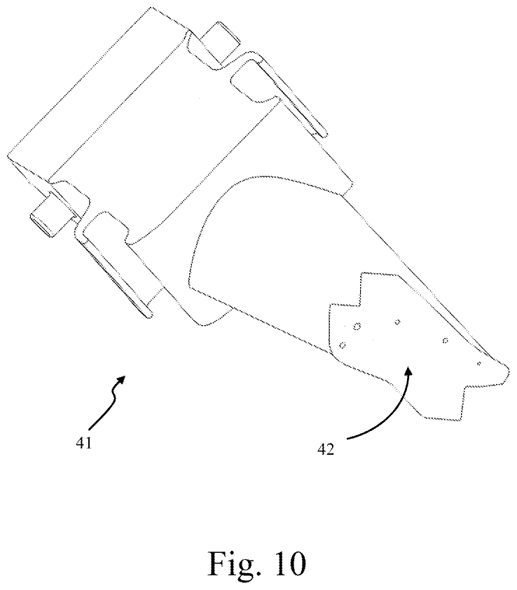

The spaces previously occupied by a number of pairs of cores a1b1-a5b5 include stepped cooling air channels in the casting, while the superalloy in the spaces between channels forms internal walls of the separating the cooling channels. FIG. 10 illustrates a hollow blade casting 41 made in accordance with the present invention with a number of stepped radial channels 42 created therein.

The present invention makes possible the production of components such as blades or vanes for gas turbine engine via investment casting process, having stepped cooling channels with variant diameter which, as described earlier in the specification were believed to be impossible or very difficult by using ceramic cores.

The stepped radial cooling channels is formed in novel technique by using several pairs of cores while the smaller diameters cores related to airfoil of blade inserted into the larger diameter cores related to root of blade.

The present invention provides a novel approach for creating stepped cooling channels which reduces the manufacturing time and cost to a small fraction of that required for traditional STEM technique, thus it reduces the price of finished product for the customers, as a result of only using cores without any further equipment in opposite of the STEM.

The objective of this invention is to developing new technique for producing stepped radial cooling by using quartz cores that minimized machining, dimensional accuracy and repeatability of cooling channels locations in casting.

Furthermore in this invention the scraped parts are in as cast condition while the scraps of STEM technique are in machined condition so because of high cost and time consuming post casting processes such as radiography, hot isostatic press, fluorescent penetrant inspection, dimensional control, and machining, the machined parts are more expensive than the as cast parts, so the induced damages of scrap parts in STEM technique is greater than those of casting process developed in this invention.

While the invention has been explained above, it is not intended to be limited thereto and numerous changes and substitutions can be made therein without departing from the spirit and scope of the invention as set forth in the appended claims.

What is claimed is:

1. Method of casting blade or vane with internal air cooling channels comprising to form several individual bended stepped channels
bending ceramic cores belonged to airfoil holes
Inserting bended ceramic cores with smaller diameter belonged to airfoil holes into the larger diameter ceramic cores belonged to root channels to form pairs of stepped cores
Placing pairs of cores into injection mold, having several of grooves formed therein for each member of certain pair cores.
Injecting sacrificial material such as wax into the mold cavity, the wax surrounding several pairs of cores, forming a final pattern provided for shell making in investment casting process
Dewaxing the pattern by steam autoclave to leave a gap between the shell and positioned ceramic cores therein, firing the shell to achieving required strength and casting molten metal into the shell to form blade or vane casting.

2. The method of claim 1 wherein said ceramic cores include a plurality of pairs of tabular quartz cores.

3. The method of claim 2 wherein said pairs of quartz cores, each pair include airfoil core and root core.

4. The method of claim 3 wherein said airfoil core and root core, in each pair airfoil core having smaller diameter relation to root core.

5. The method of claim 4 wherein said root cores have a wall thickness proportionately to outer diameter of airfoil core and cooling channel diameter of casting.

6. The method of claim 4 wherein said airfoil core is inserted axially into root core to make each pair designed for each cooling channel.

7. The method of claim 5 wherein said airfoil cores include bends will be located in the junction of airfoil segments and root segments.

8. The method of claim 6 wherein said airfoil cores have a wall thickness between about 0.01-0.015 inch.

9. The method of claim 1 wherein said ceramic core is made of quartz or silica rich material that required to be easily leached.

10. The method according to claim 1, further comprising providing the mold cavity with the number of grooves, each groove having a depth equal to radius of each member of a pair of cores corresponding cooling channels of blade or vane casting.

11. The method of according to claim 1 wherein said sacrificial material is made of wax, plastic or other fugitive material.

12. The method according to claim 1, where placing the ceramic cores in mold cavity includes prefect locating the ceramic cores within grooves of mold cavity.

13. The method of claim 1 including adding a little wax to the end of root cores to compensating difference value of thermal expansion coefficients of quartz cores and ceramic shell.

14. The method of claim 1 including locking of airfoil cores in ceramic shell for preventing lateral movement of both members of cores, airfoil cores and root cores.

15. The method of claim 1 wherein said melt is solidified via polycrystalline solidification to produce an equiaxed grain casting.

16. The method according to claim 1, further including removal of ceramic cores from the casting by conventional leaching technique via caustic solutions.
